(19) United States
(12) Patent Application Publication
(10) Pub. No.: US 2010/0287927 A1
(43) Pub. Date: Nov. 18, 2010

(54) IMPROVEMENTS TO WAVE ENERGY CONVERTER

(75) Inventor: Sean Derek MOORE, Gosnells (AU)

Correspondence Address: NIXON & VANDERHYE, PC, 901 NORTH GLEBE ROAD, 11TH FLOOR, ARLINGTON, VA, 22203, US

(73) Assignee: PROTEAN POWER PTY LTD, West Perth, WA (AU)

(21) Appl. No.: 12/814,967

(22) Filed: Jun. 14, 2010

(30) Foreign Application Priority Data
Dec. 12, 2007 (AU) 2007906745
Dec. 8, 2008 (AU) PCT/AU2008/001806

(51) Int. Cl. F03B 13/14

(52) U.S. Cl. 60/497

(57) ABSTRACT

An improvement for a wave energy converter comprises a substantially rigid skirt adapted to be suspended from a wave energy converter below the surface of the water. The skirt includes an elongate substantially cylindrical structure extending vertically so as to form a flow path for water particles over a surface of the structure. The cylindrical structure has a series of rings of substantially equal diameter arranged concentrically at spaced vertical intervals. The curved surfaces formed by the circular cross-section of the rings, form an undulating flow path for water particles travelling in a vertical direction. In this way the vertical component of the wave energy extracted from the wave's circular water particle motion can be maximized.

### FIELD OF THE INVENTION

The present invention relates to wave energy converters for converting ocean wave energy into a more useable form, and improvements thereto.

### BACKGROUND TO THE INVENTION

At the beginning of the third millennium the concern of people everywhere is increasingly on sustainability. As people realise that fossil fuels are a finite energy resource, the search for renewable, clean energy sources has become more urgent. Global warming and climate change have focussed attention on the need to reduce our dependence on fossil fuels. One of the most promising renewable energy sources is wave energy. Although there has been a desire to harness the energy of waves for hundreds of years, past attempts have met with limited success. The successes have been on a small scale, in the order of tens to hundreds of kilowatts rather than the hundreds of megawatts required.

One of the major difficulties in the past has been to design a unit that is sufficiently robust to withstand the enormous power that is possessed by the ocean's waves. In storm conditions the wave energy can be massive, causing the destruction of many of the prior art land- or shore-based systems. The typical prior art approach to extracting wave energy has been to use a turbine or hydraulic system. There have been some attempts to use a directly driven rotary generator, as well as a directly driven linear generator. However the most common prior art energy extraction units are oscillating water columns and hydraulic linked rotary generators. These are typically used in near-shore, and on-shore installations. Another drawback of such prior art systems is their need to be close to shore where the available energy is low due to the wave attenuation with the seafloor.

In commonly-owned International Application No PCT/AU2007/00940, the contents of which are incorporated herein by reference, a tension mooring system and a wave energy converter is disclosed that can be used either near-shore or offshore to extract a maximum amount of ocean wave energy.

The water particles within a wave (in deep water) move in a circular orbit and it is this mechanism which allows a wave to transport energy over great distances with very little loss. For water particles at the surface of the water the diameter of the circular path is equal to the wave height. However below the water surface the diameter of the water particle motion at any given depth decreases exponentially, so that at a depth equal to half the wavelength of the wave the diameter of the circular path is reduced by 95% as compared to the water's surface. Clearly the greatest energy is available at the water's surface, however to facilitate the maximum amount of energy extracted one needs to also have the means to extract the energy from the entirety of this energy gradient.

The present invention was developed with a view to providing various improvements to a wave energy converting apparatus, including a structure for maximising the wave energy that may be extracted from the energy gradient below the water surface.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided an improvement for a wave energy converter, the improvement comprising:

a substantially rigid skirt adapted to be suspended from a wave energy converter below the surface of the water, the skirt comprising an elongate substantially cylindrical structure extending vertically so as to form a flow path for water particles over a surface of the structure, the surface of the structure being shaped to facilitate the extraction of energy from the energy gradient of the cross-section of a travelling wave.

Preferably the surface of the cylindrical structure is shaped so as to form an undulating flow path for water particles travelling in both the horizontal and vertical directions wherein, in use, the horizontal and vertical wave energy extracted from the water particles can be maximised. In one embodiment the surface of the cylindrical structure comprises a series of curved surfaces so as to form an undulating flow path for water particles travelling in a vertical direction. Advantageously the substantially cylindrical structure comprises a series of rings of substantially equal diameter arranged concentrically at spaced vertical intervals so as to form an undulating flow path for water particles travelling in a vertical direction.

According to another aspect of the present invention there is provided a multipoint mooring system for a wave energy converting apparatus, the apparatus having a structure with a submerged member provided in connection therewith below the mean water level, the multipoint mooring system comprising:

a plurality of elongate flexible members attached at one end to a ballast means, each elongate flexible member extending to a respective counterbalancing means adapted to be suspended from the submerged member via a pulley mechanism.

Preferably the elongate flexible members are spaced apart from each other so as to increase the degrees of freedom over which the wave energy converting apparatus can extract energy. Advantageously the multipoint mooring system comprises three elongate flexible members spaced apart equidistantly from each other so as to allow the wave energy converting apparatus to extract energy from all six degrees of freedom.

According to a further aspect of the present invention there is provided a wave energy converter comprising:

a structure with a member provided in connection therewith at least partially submerged below the mean water level;

a plurality of elongate flexible members attached at one end to a ballast means, each elongate flexible member extending to a respective counterbalancing means adapted to be suspended from the at least partially submerged member via a pulley mechanism.

Preferably the wave energy converter further comprises a substantially rigid skirt provided in connection with the at least partially submerged member, the skirt comprising an elongate substantially cylindrical structure extending vertically so as to form a flow path for water particles over a surface of the cylindrical structure, the surface of the cylindrical structure being shaped to facilitate the extraction of energy from the energy gradient of the cross-section of a travelling wave.

Preferably the pulley mechanism comprises a plurality of pulleys, each pulley being adapted to receive a respective elongate flexible member looped about the pulley whereby, in use, linear movement of the elongate member can be converted by the pulley into a rotational torque for driving energy conversion means in the wave energy converting apparatus.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the improvement for a wave energy converter, the multipoint mooring system and the improved pulley mechanism of the invention, given by way of example only, with reference to the accompanying drawings, in which:

FIG. 1 is a side elevation of a preferred embodiment of a skirt for a wave energy converter according to one aspect of the present invention;

FIG. 2 is a side elevation of a simple point energy absorber with the skirt of FIG. 1 affixed thereto;

FIG. 3 illustrates schematically the flow path of water particles over a surface of the skirt which is adapted to extract wave energy from water particles travelling in a vertical direction;

FIG. 4 illustrates schematically the flow path of water particles over a surface of the skirt which is adapted to extract wave energy from water particles travelling in a horizontal direction;

FIG. 5 is a top perspective view of an embodiment of a wave energy converter according to a second aspect of the present invention with the skirt of FIG. 1 affixed or integral thereto;

FIG. 6 is a transparent perspective view a first embodiment of a multipoint mooring system for the wave energy converter of FIG. 5, in which a counterweight system according to a third aspect of the present invention is visible; and

FIG. 7 is an enlarged detail view of the counterweight system for a wave energy converter of FIG. 6.

### DETAILED DESCRIPTION OF PREFERRED EMBODIMENTS

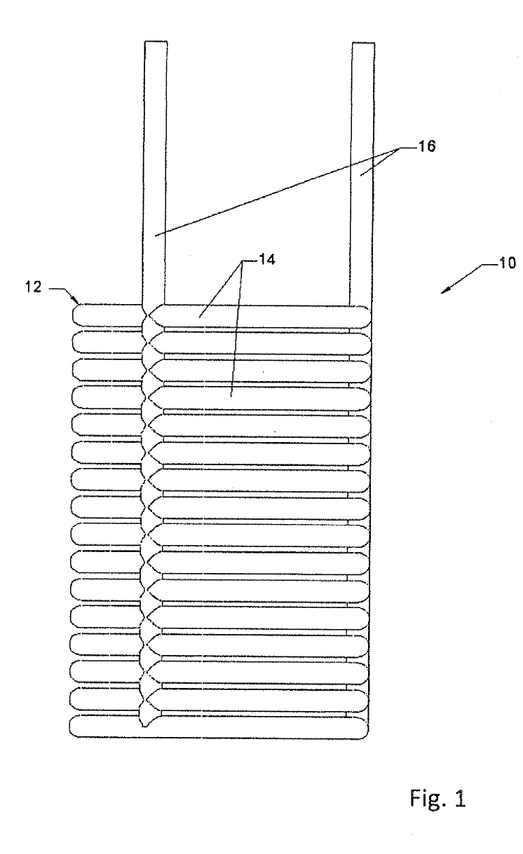

A preferred embodiment of an improvement for a wave energy converter in accordance with the invention, as illustrated in FIGS. 1 to 5, comprises a substantially rigid skirt 10 adapted to be suspended from a wave energy converter below the surface of the water. The skirt 10 comprises an elongate substantially cylindrical structure 12 extending vertically so as to form a flow path for water particles over a surface of the structure, The surface of the structure is shaped to facilitate the extraction of energy from the energy gradient of the cross-section of a travelling wave. Although most of the wave energy is available at the water's surface, to facilitate the maximum energy extraction it is desirable to extract the energy from the energy gradient below the water surface, The use of an elongate structure 12 allows the energy of the travelling wave to be extracted over a greater proportion of the energy gradient.

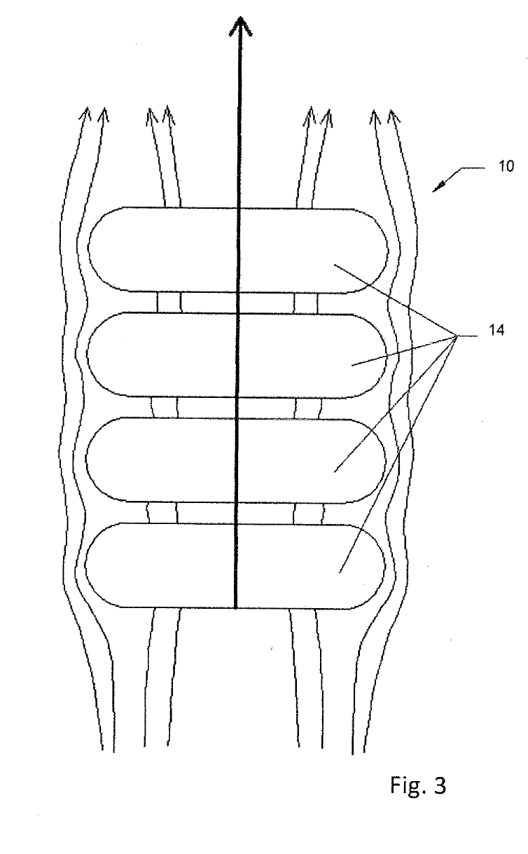

Preferably the surface of the cylindrical structure 12 is shaped so as to form an undulating flow path for water particles travelling in a vertical direction, as illustrated schematically in FIG. 3. In this embodiment the surface of the cylindrical structure comprises a series of curved surfaces so as to form an undulating flow path for water particles travelling in a vertical direction. Advantageously the substantially cylindrical structure 12 comprises a series of rings 14 of substantially equal diameter arranged concentrically at spaced vertical intervals. The rings 14 are held at spaced intervals by a plurality of elongate support members 16, arranged so as form the substantially cylindrical structure 12. It may be advantageous to vary the diameter of successive rings 14, and/or the radius of curvature of the cross-section of successive rings 14, in descending or ascending vertical order, so as to facilitate maximum energy extraction over a greater proportion of the energy gradient.

As can be seen most clearly in FIG. 3, the curved surfaces formed by the circular cross-section of the rings 14, form an undulating flow path for water particles travelling in a vertical direction. The undulating flow path forces the water particles travelling vertically to deviate around the curved surfaces of the rings 14 so that some of the vertical energy is thereby transferred to the rings 14. In this way the vertical component of the wave energy extracted from the wave's circular water particle motion can be maximised.

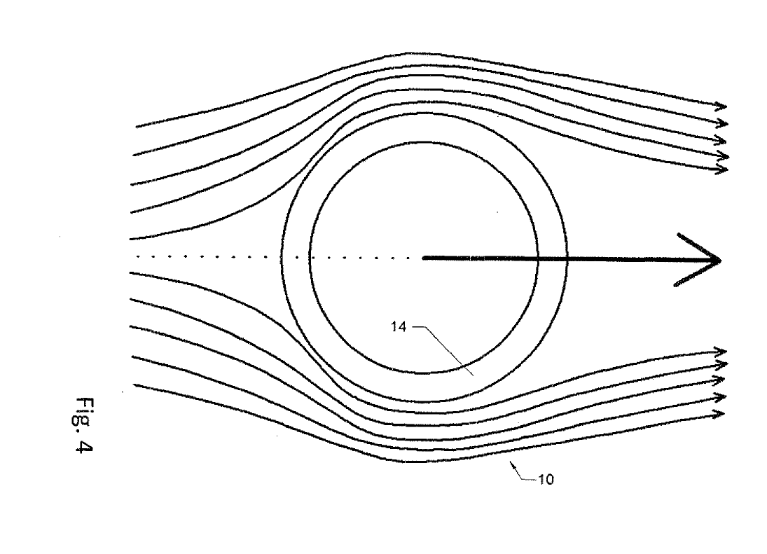

Similarly, as can be seen most clearly in FIG. 4, the curved surfaces formed by the circular shape of the rings 14 viewed in plan view, form a curved flow path for water particles travelling in a horizontal direction. The curved flow path forces the water particles travelling horizontally to deviate around the curved surfaces of the rings 14 so that some of the horizontal energy is thereby transferred to the rings 14. In this way the horizontal component of the wave energy extracted from the wave's circular water particle motion can also be maximised.

Both the additional vertical and horizontal wave energy components of the wave's circular water particle motion extracted by the skirt 10 are transferred to a wave energy converter (WEC) via the support members 16. FIGS. 3 and 4 illustrate how the fluid flow around the skirt 10 will cause a specific force to be applied to the skirt and hence to the WEC. In FIGS. 3 and 4 it can be seen how a degree of separation of the boundary layer occurs in the fluid flow as it moves around the skirt 10. However, in practice, the maximum amount of pressure drag is related to the Reynolds number of the boundary layer interaction. With this in mind an advantageous design consideration is to size the skirt to maximise the drag.

By using the skirt 10 to extract the energy over a greater proportion of the energy gradient, the dynamics of how the energy is extracted by a WEC changes. The skirt 10 can be attached to almost any WEC to facilitate the extraction of energy from the energy gradient of the cross-section of a travelling wave. However the skirt 10 works particularly well with a Point-Absorber (PA) class of wave energy converters. A PA extracts energy by creating a set of interference pattern oscillations such that a standing wave is produced on the lee side of the PA and a non-interfering wave is sent away from the PA towards the seaward direction. The closer these phase shifted oscillations match those of the approaching wave the more energy the PA will be able to extract. A saying in the wave energy conversion field is “A good wave extractor is a good wave producer.” This helps to illustrate the dynamics required when a PA is used to extract wave energy.

The mechanism for wave energy extraction used by virtually every prior art PA is inherently very inefficient and prone to limitations due to the frequency range over which it can operate. Typically a PA will work well at its resonant frequency; however the performance drops off rapidly for all frequencies outside of this resonant peak.

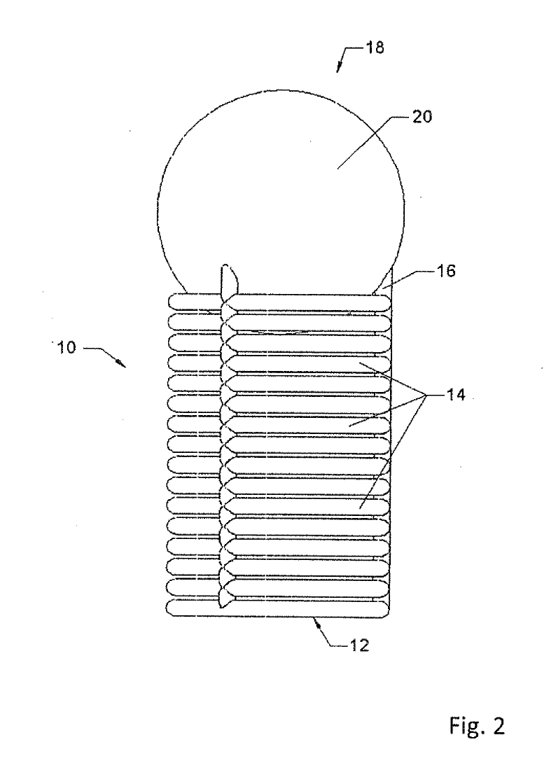

To overcome these operational limitations of a PA a skirt may be employed to change the dynamics and dramatically improve the energy extraction performance. FIG. 2 shows a simple PA 18 comprising a spherical buoyant body 20, having a skirt 10, in accordance with the preferred embodiment, suspended from it below the water surface. By adding a skirt to the PA 18 the system changes from a solely resonant oscillating system, which is reliant upon creating a matching counter wave, to a system that uses powerful fluid dynamical principles, in addition to the body's oscillations, to absorb the incident wave energy as described above with reference to FIGS. 3 and 4.

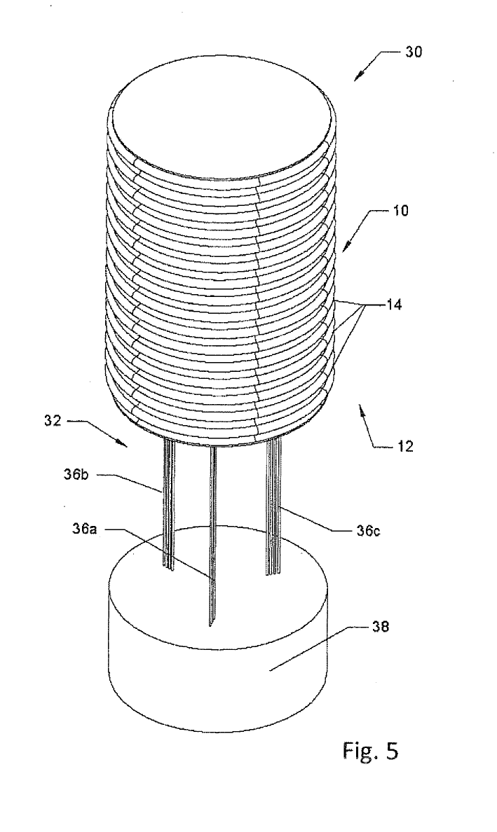

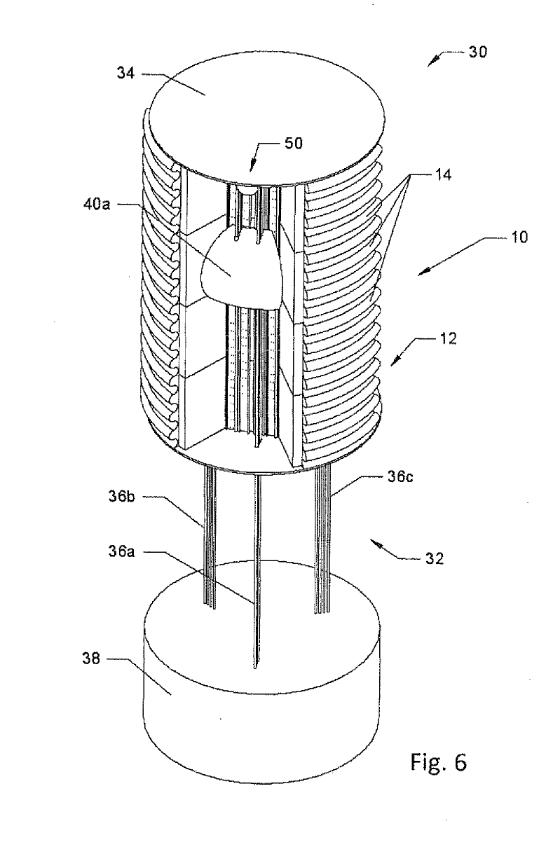

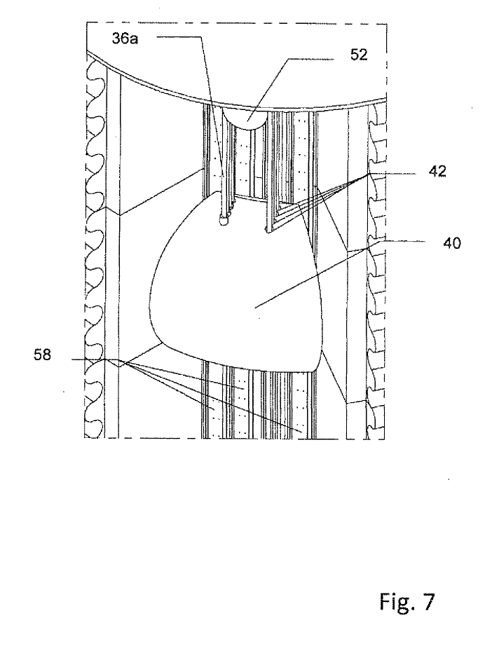

FIG. 5 illustrates a preferred embodiment of an improved WEC 30 in accordance with another aspect of the present invention, with a skirt 10 partially submerged below the surface of the water. The same fluid dynamical principles apply to this WEC 30 with a skirt 10 affixed thereto, to facilitate improved extraction of energy from the energy gradient of the cross-section of a travelling wave. The structure and operation of the WEC 30 will be described in more detail below with reference to FIGS. 6 and 7.

Although in the described embodiment the skirt 10 is shown as a series of appropriately sized rings 14, a variety of other shapes and configurations of the skirt could also be used which employ the same basic principles. Some examples of these alternate configurations include:
A smooth cylindrical structure, either solid or hollow;
A corrugated cylinder, either solid or hollow;
A cylindrical structure, either solid or hollow, with radial holes;
A series of interconnected horizontal cylindrical rings and vertical cylinders to form a cylindrical mesh;
A polygon shaped cylindrical structure may also be used in place of a circular cylindrical structure,

The WEC 30 of FIGS. 5 and 6 is shown with a preferred embodiment of a multipoint mooring system 32 in accordance with another aspect of the present invention. In the prior art tension mooring system for a WEC disclosed in PCT/AU2007/00940, the WEC has a structure with a submerged member provided in connection therewith below the mean water level. The mooring system of PCT/AU2007/00940 comprises a single elongate flexible member, extending from a ballast means to a counterbalancing means adapted to be suspended from the submerged member via a pulley mechanism.

The WEC 30 of FIGS. 5 and 6 is similar in that it has a structure with a member 34 provided in connection therewith partially submerged below the mean water level. The multipoint mooring system 32 comprises a plurality of elongate flexible members 36. Each of the elongate flexible members 36 is attached at one end to a ballast means 38, and extends to a respective counterbalancing weight 40 adapted to be suspended from the partially submerged member 34 via a pulley mechanism 50. FIGS. 6 and 7 illustrate one portion of the multipoint mooring system 32 of FIG. 5 housed within the partially submerged member 34 of the WEC 30.

In the embodiment of the multipoint mooring system 32 illustrated in FIGS. 5 to 7, three elongate flexible members in the form of cable groups 36a, 36b and 36c are provided, all of which are anchored at one end to a clump weight 38 which typically rests on the sea floor. The respective counterbalancing weights 40a, 40b and 40c are attached to the other end of the respective cable groups 36a, 36b and 36c. In this embodiment the cable groups 36 each comprise four cables. Preferably each of the counterbalancing weights 40 are provided with four apertures 42 extending there through, through which the four cables of the respective cable groups 36 are slidably received (see FIG. 7) on their return path to the clump weight 38.

Each cable 36 is looped about a pulley 52 whereby, in use, linear movement of the cable 36 can be converted by the pulley 52 into a rotational torque for driving energy conversion means in the wave energy converting apparatus 30. The pulley 52, as shown in FIG. 7, is an ordinary multi-cabled pulley, which has the four cables of cable group 36a hung (or looped) over the pulley. The result is that the cables of cable group 36 have about 180° of contact with the pulley. The use of a cable group 36 facilitates a better grip between the pulley 52 and the cables of cable group 36 to transmit the desired rotational torque to an electrical generator (not visible) or the like.

Each counterbalancing weight 40 moves up and down along a guide rail 58. Guide rail 58 is designed to stop the counterbalancing weight 40 from moving independently of the buoy section, as a safety feature. The guide rail 58 also limits the travel of the counterbalancing weight 40 so that it remains enclosed within the protective enclosure of the buoy. This provides another safety feature that will help to prevent any marine creature or person from getting injured during operation of the WEC 30.

Advantageously the cable groups 36 are spaced apart from each other at a fixed distance so as to increase the degrees of freedom over which the wave energy converting apparatus 30 can extract wave energy. Another benefit of having more than one cable group 36 is that the load on the system is distributed over each of the cable groups 36, rather than all being carried by one cable. A still further benefit is that the possibility of a single cable getting tangled about itself is obviated. Each counterbalancing weight 40 will always want to return the WEC 30 to the shortest distance between itself and the mooring on the sea floor. Therefore in the event that there was a severe yaw and the cable groups 36 got twisted around each other, the force applied by the counterbalancing weights 40 would work to untwist the cables 36 thus undoing a tangle. In addition to the above, it is possible to attach a respective guide (not shown) for each of the cable groups 36 to the skirt 10, through which the cable groups 36 can pass so that the possibility of a cable tangle will be practically eliminated.

In PCT/AU2007/00940 the WEC with a single mooring point allows the WEC to extract energy from five of the six possible degrees of freedom. However a multipoint mooring system with three or more mooring cables would be able to extract energy from all six degrees of freedom. The ability to extract energy from all six degrees of freedom means that a WEC with a multipoint mooring system would be omni-directional and be able to extract energy from a wave regardless of the direction of its approach. This means that the WEC would not have to re-orient or track itself to the prevailing wave direction and therefore will always be producing maximum power even in non-uniform seas.

The provision of a multipoint mooring system is a very significant step in the development of the WEC as no other WEC is currently able to achieve energy extraction regardless of the wave direction. The ramification of this configuration will significantly improve the operation of the WEC and ultimately increase its power output, its consistency, its reliability, and help to lower the cost of the power generated.

In the illustrated embodiment, the pulley system 50 drives a separate generator directly via each of the pulleys 52, so that in a three cable multipoint mooring system there would be three separate generators (or other energy conversion means) in each WEC 30. In another embodiment it is possible to use a suitable gearing of the pulley drives to provide a mechanical advantage prior to driving the energy conversion means. Advantageously the cylindrical structure 12 of the skirt is also able to act as a guide 58 and safety guard for the movement of the counterbalancing weights 40.

Now that preferred embodiments of the improvements to a wave energy converter (WEC) have been described in detail, it will be apparent that the improved WEC with skirt provides a number of advantages over the prior art, including the following:
(i) The skirt facilitates the extraction of energy from the energy gradient of the cross-section of a travelling wave below the surface of the water.
(ii) It dramatically improves the energy extracted by a point absorber, changing its dynamics from a simple inefficient oscillating system to a system that uses powerful fluid dynamical principles, in addition to the oscillations, to absorb the incident wave energy.
(iii) The multipoint mooring system allows a WEC to become omni-directional so that it can extract the energy from a travelling wave that presents from any direction without having to reorient itself before it can extract energy.
(iv) The improved pulley mechanism of the WEC substantially eliminates tangling and ensures that linear movement of the cable can be converted into a rotational torque for driving energy conversion means in the WEC.

It will be readily apparent to persons skilled in the relevant arts that various modifications and improvements may be made to the foregoing embodiments, in addition to those already described, without departing from the basic inventive concepts of the present invention. For example, in each of the described embodiments the submerged member of the WEC is of substantially cylindrical configuration. However this is by no means essential, as it could be of any suitable shape or configuration. Therefore, it will be appreciated that the scope of the invention is not limited to the specific embodiments described.

1. A wave energy converter, comprising:
a substantially rigid skirt adapted to be suspended least partially below a surface of water, the skirt including an elongate substantially cylindrical structure extending vertically and forming a flow path for water particles over a surface of the structure, the surface shaped to facilitate the extraction of energy from an energy gradient of a cross-section of a travelling wave in the water.

2. The a wave energy converter as defined in claim 1, wherein the surface of the cylindrical structure forms an undulating flow path for the water particles travelling in both horizontal and vertical directions.

3. The wave energy converter as defined in claim 1, wherein the surface of the substantially cylindrical structure comprises a series of curved surfaces forming an undulating flow path for the water particles travelling in a vertical direction.

4. The wave energy converter as defined in claim 3, wherein the substantially cylindrical structure comprises a series of rings of substantially equal diameter arranged concentrically at spaced vertical intervals forming an undulating flow path for water particles travelling in a vertical direction.

5. A multipoint mooring system for a wave energy converting apparatus, the apparatus having a structure with a member provided in connection therewith at least partially submerged below a mean water level, the multipoint mooring system comprising:
a plurality of elongate flexible members attached at one end to a ballast device, each elongate flexible member extending to a respective counterbalancing device adapted to be suspended from the at least partially submerged member via a pulley mechanism.

6. A multipoint mooring system as defined in claim 5, wherein the elongate flexible members are spaced apart from each other so as to increase the degrees of freedom over which the wave energy converting apparatus can extract energy.

7. A multipoint mooring system as defined in claim 6, wherein three of the elongate flexible members are spaced apart equidistantly from each other so as to allow the wave energy converting apparatus to extract energy from all six degrees of freedom.

8. A multipoint mooring system as defined in claim 5, wherein each elongate flexible member comprises a cable group having a plurality of cables.

9. A wave energy converter comprising:
a structure with a member provided in connection therewith at least partially submerged below a mean water level;
a plurality of elongate flexible members attached at one end to a ballast device, each elongate flexible member extending to a respective counterbalancing device adapted to be suspended from the at least partially submerged member via a pulley mechanism.

10. A wave energy converter as defined in claim 9, further comprising a substantially rigid skirt provided in connection with the at least partially submerged member, the skirt comprising an elongate substantially cylindrical structure extending vertically forming a flow path for water particles over a surface of the cylindrical structure, the surface of the cylindrical structure shaped to facilitate the extraction of energy from an energy gradient of a cross-section of a travelling wave.

11. A wave energy converter as defined in claim 10, wherein the surface of the cylindrical structure forms an undulating flow path for water particles travelling in both the horizontal and vertical directions wherein, in use, the horizontal and vertical wave energy extracted from the water particles can be maximized.

12. A wave energy converter as defined in claim 10, wherein the surface of the substantially cylindrical structure comprises a series of curved surfaces so as to form an undulating flow path for water particles travelling in a vertical direction.

13. A wave energy converter as defined in claim 12, wherein the substantially cylindrical structure comprises a series of rings of substantially equal diameter arranged concentrically at spaced vertical intervals so as to form an undulating flow path for water particles travelling in a vertical direction.

14. A wave energy converter as defined in claim 9, wherein the pulley mechanism comprises a plurality of pulleys, each pulley being adapted to receive a respective elongate flexible member looped about the pulley.

15. A wave energy converter as defined in claim 14, wherein each elongate flexible member comprises a cable group and each pulley comprises a multi- cabled pulley which has the cables of the cable group hung over the pulley.

16. A wave energy converter as defined in claim 9, further comprising a guide rail for each counterbalancing device, wherein the movement of the counterbalancing device is confined within predetermined limits.

17. (canceled)

18. (canceled)
